(19) United States
(12) Patent Application Publication
(10) Pub. No.: US 2014/0053460 A1
(43) Pub. Date: Feb. 27, 2014

(54) Graft element, system and method for joining plant stem sections using such graft element, and system and method for preparing such graft element

(71) Applicant: IG Specials B.V., Gameren (NL)

(72) Inventors: Wim STRUIJK, DELWIJNEN (NL); Wim VAN DER EL, AMEIDE (NL); Dirk Jan DE KONING, SON EN BREUGEL (NL); Willem Nicolaas SCHOUTEN, NEDERHEMERT (NL)

(73) Assignee: IG Specials B.V., Gameren (NL)

(21) Appl. No.: 13/949,341

(22) Filed: Jul. 24, 2013

Related U.S. Application Data
(63) Continuation of application No. PCT/EP2012/051067, filed on Jan. 24, 2012.

(30) Foreign Application Priority Data
Jan. 24, 2011 (NL) 1038539

(51) Int. Cl. A01G 1/06; B26D 7/02

(52) U.S. Cl. CPC A01G 1/06; B26D 7/02
USPC 47/6; 83/13; 83/465

(57) ABSTRACT

The present invention relates to a graft element for joining together plant stem sections. The graft element is made of a resilient material and takes the form of a tubular structure having a hollow center that extends in a longitudinal direction so as to form a cylinder. The graft element further comprises a side opening along its length and two elongated members. The side opening is connected to the hollow center over the entire length of the graft element. The two elongated members are located at opposite sides of the side opening and oriented substantially parallel thereto. The elongated members are provided with cutouts for receiving a gripping unit. The invention further relates to systems and methods for joining plant stem sections using the graft element. Finally, the invention relates to a system and a method for preparing the graft element.

### CROSS REFERENCE TO RELATED APPLICATIONS

This application is a continuation of PCT application number PCT/EP2012/051067 filed on 24 Jan. 2012, which claims priority from Netherlands application number NL 1038539 filed on 24 Jan. 2011. All applications are hereby incorporated by reference in their entireties.

### BACKGROUND OF THE INVENTION

1. Field of the Invention

The invention relates to a graft element for joining together plant stem sections. The invention further relates to a system and a method for preparing such graft element. Finally, the invention relates to a system and a method for joining together plant stem sections, preferably by means of such graft element.

2. Description of the Related Art

It is well known in the fields of horticulture and fruit that a plant section of a preferred species of plant may be transplanted onto a section of a hardier species. The plant will then grow, having the qualities of the preferred species while enjoying benefits such as resistance to disease of the hardy species. The plant section of the preferred species to be grafted is referred to as the scion. The section of the hardy plant onto which the scion is grafted is generally referred to as root stock.

For certain types of plant species grafting is systematic. Almost every rose plant consists of a scion of a selected species grafted onto a hardy root stock. Grape vines are also generally grafted. The process of grafting normally involves selecting appropriate scion and root stock sections, cutting the sections, e.g. on a perpendicular or diagonal angle, and bringing the faces of the graft together. The process of grafting is generally labor intensive. The graft must then be held or supported sufficiently to allow the two sections to grow into one another. Furthermore, the graft should, where necessary, be protected from the environment to prevent infection or damage. A conventional graft element used to hold the two sections together is a clothes peg, which applies pressure to the graft. However, such pegs are relatively heavy for small plants, in particular non-woody plants, and each peg is relatively expensive. Furthermore, the overall success rate is low, which leads to considerable wastage of plants, labor and space.

FR2693623 discloses a clip formed of an elastic material for grafting purposes. The clip is in the form of a slotted tube that can be opened and closed around a stem. The clip can also receive a supporting element, such as a stick or splint, which may assist in supporting the graft. The clip is considerably lighter than a clothes peg and more suited for use on soft-stemmed plants such as tomato plants. Nevertheless, individual placement of such clips by hand remains time consuming and can encourage the spread of plant diseases.

WO95/21520 discloses the use of a rollable sleeve for grafting purposes. The sleeve is formed of an elastic material. The sleeve is initially in the form of a ring and is subsequently rolled out to cover the graft. Although the sleeve appears to be an improvement over the use of a clothes peg, its manufacture and deployment are relatively complex.

Other examples of prior art graft elements suitable for manual deployment can be found in Japanese patent document JP2008263878.

### BRIEF SUMMARY OF THE INVENTION

In the light of the problems associated with the prior art, it would be desirable to provide an alternative procedure for grafting. There is in particular a need for a grafting device that can simply and efficiently perform grafting on relatively soft-stemmed plants. There is furthermore a need for a graft element that is easily applied and can support and protect the graft during the time taken for the graft to heal and can subsequently be removed rather easily. The grafting procedure should be swift and simple to carry out while ensuring good graft success.

For this purpose, an embodiment of the invention provides a graft element for joining together plant stem sections, the graft element being made of a resilient material and taking the form of a tubular structure having a hollow center that extends in a longitudinal direction of the graft element so as to form a cylinder, the graft element further comprising: a side opening along its length which is connected to the hollow center over the entire length of the graft element; and two elongated members at opposite sides of the side opening and oriented substantially parallel thereto, the elongated members being provided with cutouts for receiving a gripping unit. The graft element can be easily applied without damaging the plants stems. Furthermore, the graft provides sufficient support to keep the graft in place. The use of a resilient material allows the graft to adjust its form to the stems that it encloses. Furthermore, if the form of the graft element has been adjusted for placement of the stems in the graft element, the use of a resilient material allows the graft element to enclose the stems and to return to its basic shape, as much as possible. The side opening allows superfluous liquid produced by the root stock to escape from the graft in a relatively easy way, which precludes rotting of stems, and thus improves the quality of the grafting process.

The cutouts of the elongated members may take the form of grooves, e.g. wedge-shaped grooves, or tubes.

In some embodiments, the cylinder has a substantially circular cross-section. Such cross-section is easy to manufacture and can be applied for the grafting of many types of plants.

In some embodiments the width of the side opening close to the inner surface of the cylinder is smaller than the width near the outer surface of the graft element. In some further embodiments thereof, the cross-sectional shape of the side opening is substantially wedge-shaped. The use of this type of side opening allows for a relatively large surface area that can be used to keep the graft in place, while liquid being produced by the root stock can be removed relatively easy.

Embodiments of the invention further relate to a method for joining together plant stem sections by means of a graft element as described above. The method comprises: providing a graft element by means of a gripping apparatus comprising two gripping units provided with extended portions, the gripping units being arranged for holding the graft element and controllably opening the side opening against a repelling force of the resilient material; providing a stem of a root stock to be grafted; providing a stem of a scion to be grafted; and positioning the stems of the root stock and the scion in the graft element by pushing the stems through the side opening by means of a stem positioning device so as to allow the formation of a graft.

Embodiments of the invention further relate to a system for joining together plant stem sections by means of a graft element as described above. The system comprises: a gripping apparatus comprising two gripping units provided with extended portions, the gripping units being arranged for holding the graft element and controllably opening the side opening against a repelling force of the resilient material; a root stock holding apparatus for providing a stem of a root stock to be grafted; a scion holding apparatus for providing a stem of a scion to be grafted; and a stem positioning device for positioning the stems of the root stock and the scion in the graft element by pushing the stems through the side opening so as to allow the formation of a graft.

In some embodiments, the stem positioning device comprises a pushing unit for pushing the stems towards the graft element, the pushing unit having an orientation substantially perpendicular to the main orientation of the stems. The pushing unit has the effect that the stem are directed further in a direction towards the graft element. For even further improvement of the stem positions within the graft element, the stem positioning unit may further comprise a pressing unit for applying pressure to the stems at a predetermined position, wherein the pressing unit is oriented substantially perpendicular to the pushing unit and independently moveable thereof. The predetermined position may be the center portion of the graft element.

Embodiments of the invention further relate to a method for preparing the graft element as described above. The method comprises: supplying a strand of graft element material; gripping a portion of the strand; and cutting the strand so that the graft element is formed. Preferably, the strand is supplied in a substantially horizontal fashion. Horizontal supply of the strand allows for more reliable and precise cutting as the supply is relatively independent of gravity.

In some embodiments gripping is performed by a gripping apparatus comprising a graft element supporting unit having a supporting surface for supporting the strand portion, and two gripping units provided with extended portions with a shape complementary to the elongated members of the graft element to be formed, wherein the method further comprises moving the elongated members away from each other so that the strand portion is effectively clamped on the supporting surface.

Embodiments of the invention further relate to a system for preparing the graft element as described above. The system comprises: a supply unit for supplying a strand of graft element material; a gripping apparatus for gripping a portion of the strand; and a cutting device for cutting the strand so that the graft element is formed.

In some embodiments, the gripping apparatus comprises: a graft element supporting unit having a supporting surface for supporting the strand portion; and two gripping units provided with extended portions with a shape complementary to the elongated members of the graft element to be formed; wherein the gripping units are arranged to move the elongated members away from each other so that the strand portion is effectively clamped on the supporting surface.

Preferably, the supporting surface is a concave surface having a curvature that is smaller than the curvature of the backside of the strand portion. The use of such surface may ensure that the strand portion is effectively clamped during the cutting executed by the cutting device.

Embodiments of the invention further relate to a method for joining together plant stem sections by means of a graft element, the method comprising: providing a stem of a root stock to be grafted, the root stock stem comprising a root stock end for receiving the scion stem; providing a stem of a scion to be grafted, the scion stem comprising a scion end for receiving the root stock stem; positioning the stems next to each other such that the root stock end is positioned higher than the scion end; cutting the stems at a level between the root stock end and the scion end with a single movement; positioning the stems of the root stock and the scion on top of each other; and providing a graft element around the cut stems.

Cutting the stems with a single movement may be executed with a cutting blade that cuts the stems at an angle between 0° and 60° with a direction substantially perpendicular to the orientation of the stems. The most suitable cutting angle may vary per type of plant to be grafted.

Embodiments of the invention further relate to a system for joining together plant stem sections by means of a graft element, the system comprising: a root stock holding apparatus for providing a stem of a root stock to be grafted, the root stock stem comprising a root stock end for receiving the scion stem; a scion holding apparatus for providing a stem of a scion to be grafted, the scion stem comprising a scion end for receiving the root stock stem; a control unit for controlling the root stock holding apparatus and the scion holding apparatus for positioning the stems next to each other such that the root stock end is positioned higher than the scion end; a cutting unit; and an apparatus for providing the graft element; wherein the cutting unit is arranged for cutting the stems with a single movement at a level between the root stock end and the scion end and wherein the control unit is further arranged for controlling the root stock holding apparatus and the scion holding apparatus for positioning the stems of the root stock and the scion on top of each other after cutting.

The cutting unit may comprise a cutting blade with an orientation at an angle between 0° and 60° with a direction substantially perpendicular to the orientation of the stems to be cut.

### BRIEF DESCRIPTION OF THE DRAWINGS

Various aspects of the invention will be further explained with reference to embodiments shown in the drawings wherein:

FIG. 1A schematically shows a graft element according to an embodiment of the invention;

FIG. 1B schematically shows a graft element according to another embodiment of the invention;

FIG. 2A shows an elevated view of an embodiment of a graft element preparation system including a cutting device for preparing the graft element of FIG. 1; FIG. 2B shows an elevated view from the opposite side as compared to FIG. 2A of the same embodiment. FIG. 2C shows an elevated view of the same embodiment from the same side as depicted in FIG. 2B, further including an embodiment of a graft element gripping apparatus;

FIG. 3 shows a more detailed view on the cutting device within the preparation system of FIGS. 2A-2C;

FIGS. 4A-4C schematically show three stages of a graft element preparation procedure executed with a graft element gripping apparatus;

FIGS. 5A, 5B show an elevated view of an arrangement comprising a graft element gripping apparatus at the left side and a graft application apparatus at the right side for performing a graft application procedure according to an embodiment of the invention at two different stages within the graft application procedure;

FIG. 6A schematically shows a side view of the stem positioning device viewed from the graft element gripping apparatus in FIGS. 5A,5B;

FIG. 6B schematically shows a side view of the gripping units holding the graft element viewed from the graft application apparatus in FIGS. 5A, 5B;

FIGS. 7A-7H schematically show different stages of the graft element application procedure viewed from above with the graft element gripping apparatus at the top and the pushing unit of a stem positioning device at the bottom of the figures;

FIG. 8 schematically show a side view of a plant provided with a graft element after usage after the procedure of FIGS. 7A-7H;

FIG. 9A schematically shows an elevated side view of a system for joining together plant stem sections according to an embodiment of the invention;

FIG. 9B schematically shows a side view of a portion of the system of FIG. 9A viewed from the right side in FIG. 9A;

FIG. 9C schematically shows a top view of a gripping unit for holding a stem section viewed from the top side in FIG. 9B;

FIGS. 10A-10C schematically show an elevated side view of a portion of the system of FIG. 9A at different stages of joining together plant stem sections, wherein the elevated views have the same orientation as used in FIG. 9A. FIG. 10D schematically shows a side view of the system of FIG. 9A viewed from the right side when a graft has been formed; and

FIG. 11A schematically shows a top view of an arrangement for cutting stem sections according to an embodiment of the invention. FIG. 11B shows a side view of the arrangement of FIG. 11A along the line XIB-XIB' in FIG. 11A while looking in the direction of the arrows. FIG. 11C shows a side view of the arrangement of FIG. 11A along the line XIC-XIC′ in FIG. 11A while looking in the direction of the arrows.

### DESCRIPTION OF ILLUSTRATIVE EMBODIMENTS

The following is a description of various embodiments of the invention, given by way of example only and with reference to the drawings.

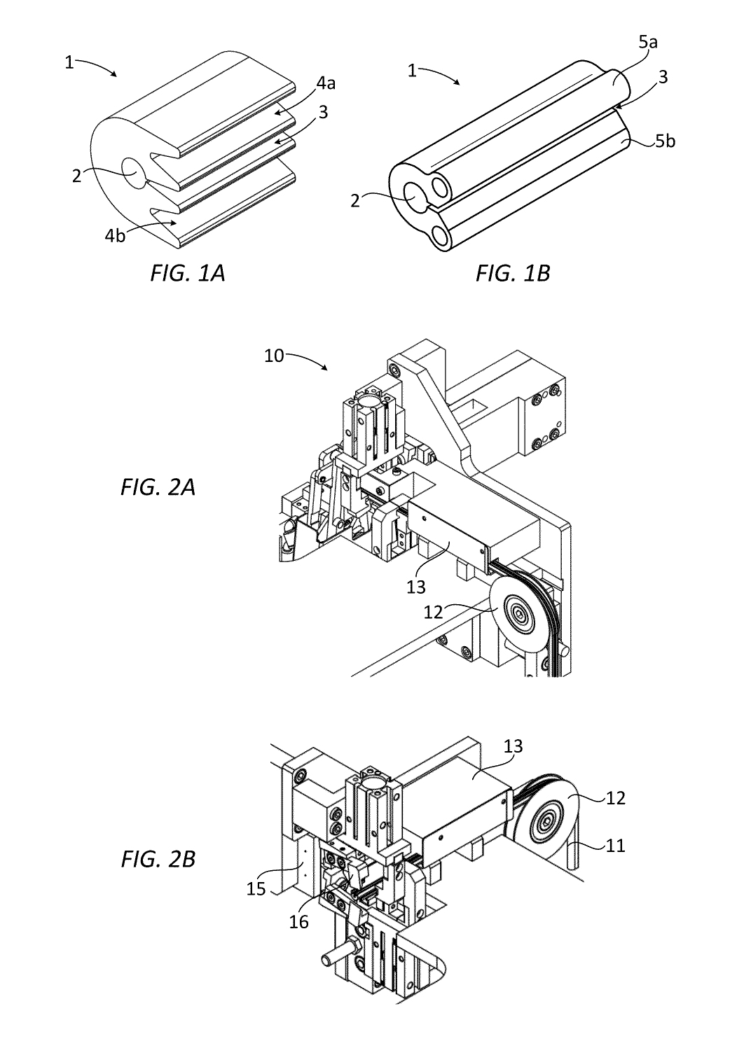

FIGS. 1A, 1B both schematically show a graft element 1 according to an embodiment of the invention. The graft element 1 is made of a resilient material, for example an elastomeric material such as silicone. More examples of suitable materials include, but are not limited to, low-density polyethylene (LDPE), a thermoplastic elastomer (TPE) and a liquid silicone rubber (LSR). Preferably, the length of the graft element is such that it provides sufficient support at the excess of as little material as possible. A typical length of the graft element 1 is about 6-16 mm, preferably about 8-14 mm, more preferably about 10-12 mm. For example, for tomato plants a size of 12 mm turns out to provide good results.

The graft element 1 takes the form of a tubular structure having a hollow center that extends in a longitudinal direction of the graft element so as to form a cylinder 2. The expression “cylinder” throughout this description refers to a structure having two substantially parallel ends of similar cross-sectional size and shape connected with each other over a distance that is greater than the dimensions of the cross-section at the ends.

The graft element 1 further comprises a side opening 3 along its length, which side opening 3 is connected to the cylinder 2. As a result the outer surface of the graft element 1 is connected to the inner surface of the cylinder 2 over the entire length of the graft element 1. The side opening 3 is preferably narrow close to the center cylinder 2 and becomes wider while moving radially outwards. For example, the cross-sectional shape of the side opening may be substantially wedge-shaped.

The cylinder 2 is arranged to allow insertion of a cut stem of a root stock through the side opening 3 such that the stem of the root stocks extends through one end of the cylinder 2. The cylinder 2 is further arranged to allow insertion of the cut stem of a scion through the side opening 3 such that the stem of the scion extends through an opposite end of the cylinder 2. The dimensions of the cylinder 2 are such that they substantially coincide with the smallest of the dimensions of the stem of the root stock and the dimensions of the stem of the scion. These dimensions ensure that the graft element 1 applies pressure on the graft that is formed.

Preferably, the cross-sectional shape of the cylinder 2 substantially corresponds to the shape of the cross-sectional shape of the stems to be grafted. As many stems have substantially circular shape, such shape is preferably used for the cross-sectional shape of the cylinder 2. A circular shape has the advantage that pressure forces are equally spread over the inner surface of the cylinder. Furthermore, due to the substantially circular shape pressure forces are directed radially inwards, which improves the stability of the graft. Note that cylinders 2 with a non-circular cross-section, such as a cross-section having a shape of an ellipse, a rectangle, a square, or another multi-angle shape such as a hexagonal or octagonal shape, may also be used, particularly in case the stems have a corresponding non-circular shape as well.

The side opening 3 is not only of use during the graft application procedure, as will be discussed in more detail below, but also allows moisture to escape from the graft after placement. This appears to lower the chance that stems deteriorate.

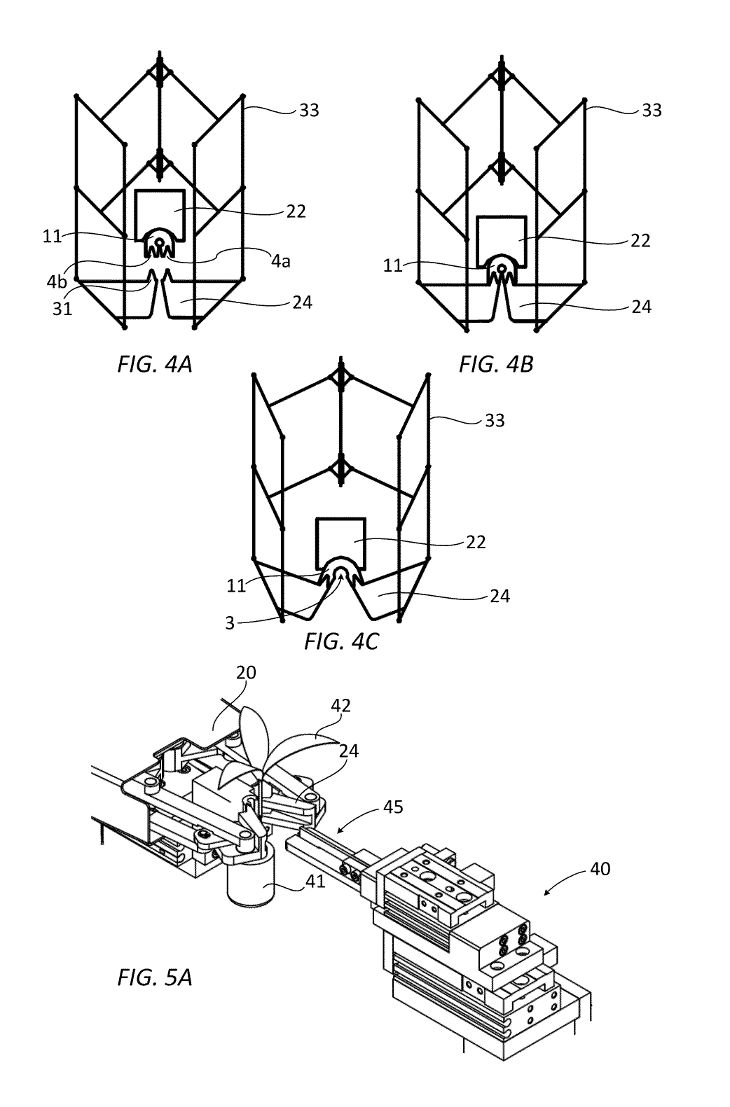

Furthermore, the graft element 1 is provided with two elongated members at opposite sides of the side opening 3 and oriented substantially parallel thereto. The elongated members are provided with cutouts for receiving a gripping unit as will be discussed with reference to FIGS. 4A-4C.

In FIG. 1A, the cutouts of the elongated members take the form of grooves 4a, 4b. In the case the cutouts take the form of grooves 4a, 4b, the cross-sectional shape of the grooves 4a, 4b is preferably substantially wedge shaped as shown in FIG. 1A, but different shapes are feasible as well.

In FIG. 1B, the cutouts of the elongated members take the form of tubes 5a, 5b.

The side of the graft element 1 at which the side opening 3 and the elongated members are located will further be referred to as front side. The other side will be referred to as backside. Embodiments of the invention will further be described with reference to the embodiment of the graft element 1 shown in FIG. 1A.

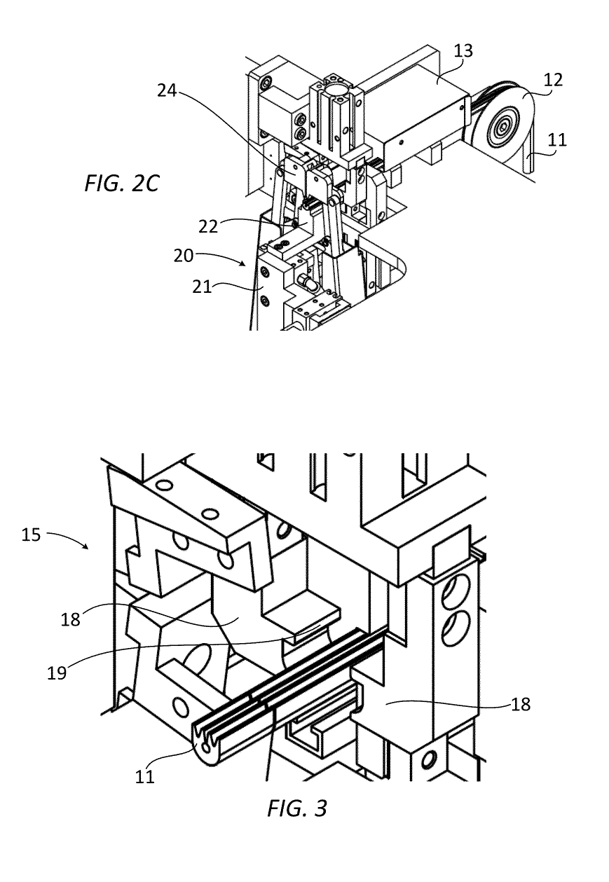

FIGS. 2A-2C schematically show three different elevated views of an embodiment of a graft element preparation system 10 for preparing the graft element of FIG. 1A. In particular, FIG. 2A shows a right side elevated view of an embodiment of a graft element preparation system including a cutting device for preparing the graft element of FIG. 1. FIG. 2B shows a left side elevated view of the same embodiment. Finally, FIG. 2C shows a left side elevated view of the same embodiment, further including an embodiment of a graft element gripping apparatus. The preparation unit 10 comprises a strand supply unit (not shown) for supplying a strand 11 or string of material from which grafts elements are to be made. The strand supply unit may take the form of a coil around which the strand is winded. The strand of graft element material has a shape similar to the graft element with the exception that the strand is of much greater length. The strand may be guided, for example via a pulley 12 and a guiding unit 13, towards a graft element gripping apparatus 20 that cooperates with a cutting device 15. The guiding unit may take the form of a U-shaped surface opposite of which a plate is positioned. The backside of the graft element to be formed is then guided while sliding over the U-shaped surface, while the plate fits into the opening and ensures that the strand 11 does not rotate during supply movement.

Preferably, as shown in FIGS. 2A-2C the strand 11 is provided to the gripping apparatus 20 horizontally. The expression “horizontal” corresponds to a direction substantially perpendicular to the direction of the force of gravity. Horizontal supply has the advantage that the supply can be controlled more easily as tension forces within the strand 11 caused by gravity have less influence.

The cutting device 15 comprises one or more cutting blades 16 for cutting the strand 11 of graft element material. The length of the graft element can be pre-programmed aimed at the specific type of plant to be handled, or may be steered by the computer controlling the grafting, and may be dependent on the specific graft to be covered by the graft element 1.

The graft element gripping apparatus 20 comprises a body 21 connected to a graft element supporting unit 22 and two gripping units 24. The graft element gripping apparatus 20 further comprises a controllable framework that enables the gripping units 24 to move in a lateral direction, as well as enables the gripping units 24 to rotate with respect to each other.

The cutting device 15 and the graft element gripping apparatus 20 cooperate in such a way that that graft elements 1 as discussed with reference to FIGS. 1A, 1B may be formed.

FIG. 3 shows an elevated view of the cutting device in which the cutting blades 16 have been removed for clarity. As shown in FIG. 3, the cutting device 15 comprises securing units 18 for securing the strand 11 during cutting. The securing units 18 are arranged to move towards each other in a substantially horizontal direction in case the strand 11 needs to be cut. The outer shape of each securing unit 18 comprises an extended portion 19 with a height slightly lower than the height of the strand 11. The extended portion 19 is forced over the strand 11 and effectively secures the position of the strand 11. By securing the strand 11 movement during cutting is kept to a minimum which enables accurate and reliable cutting.

FIGS. 4A-4C schematically show three stages of a graft element preparation procedure that can be performed with the graft element gripping apparatus 20 together with the preparation system 10 shown in FIGS. 2A-2C.

As schematically shown in FIGS. 4A-4C each gripping unit 24 is provided with an extended portion, further referred to as beak 31. The beaks 31 have a shape that is complementary to or matches the size and shape of the elongated members of the graft element 1 to be prepared. For example, in case of tubes 5a, 5b the elongated members may comprise a pin that fits into the tubes. In case of grooves 4a, 4b, as will be discussed below, the extended portions are about the same in size and shape as the size and shape of the grooves 4a, 4b alongside the side opening of the graft element material strand 11. The controllable framework for controlling movement of the gripping units 24 is schematically shown, and denoted by reference numeral 33.

In FIG. 4A, the strand 11 of graft element material rests on top of graft element supporting surface of the graft element supporting unit 22. The surface shape is concave. Preferably, the curvature of the surface is smaller than the curvature of the backside surface of the strand 11 of graft element material. The thickness of the supporting unit 22 (in FIG. 4A a dimension perpendicular to the paper plane), at least at the position where the graft element material is to be placed, is of about the same length as the graft element 1 that is to be prepared. The same holds for the beaks 31, and preferably the gripping units 24. The graft element material is provided by means of the strand supply unit, for example by allowing movement of the strand by unwinding a coil to release a strand of graft element material with appropriate length, e.g. 12 mm.

After placement of the strand 11 of graft element material on the concave surface of the supporting unit 22, the griping units 24 are moved towards the supporting so that the extended portions 31 of the gripping units 24 fit into the grooves 4a, 4b of the graft element material strand 11. This situation is schematically shown in FIG. 4B.

The gripping units 24 are then rotated with respect to each other by suitable controlled movement so that the grooves 4a, 4b move away from each other. As a result, the side opening 3 expands so that the center portion of the graft element material strand 11 becomes more easily accessible via the side opening 3. This situation is schematically shown in FIG. 4C. Furthermore, due to the outward movement of the grooves 4a, 4b the curvature of the backside of the strand 11 has decreased. Preferably, the outward movement is such that the resulting curvature of the backside of the strand 11 is substantially the same as the curvature of the concave surface of the supporting unit 22. In such case the outer surface of the graft element material strain is in full contact with the supporting surface of the graft element supporting unit, and the strand 11 is clamped effectively to the supporting unit 22.

For this reason, the graft element strand 11 is cut preferably at this stage by the cutting device 15 (not shown). The cutting device separates the portion of the graft element material that is supported by the supporting unit 22 of the gripping apparatus 20 from the remainder of the graft element material strand 11. As a result, a grafting element 1 of predetermined length is formed.

The graft element preparation system described above has the advantage that graft elements can be prepared on the spot, without the need of complex sorting and pick-up techniques. Furthermore, preparation is reliable, reproducible, and the system components are easy to maintain.

After formation the gripping apparatus 20 moves the graft element 1 towards a location at which the graft element is applied to a root stock and scion to form a graft. This movement may include a translational movement, a rotational movement or both.

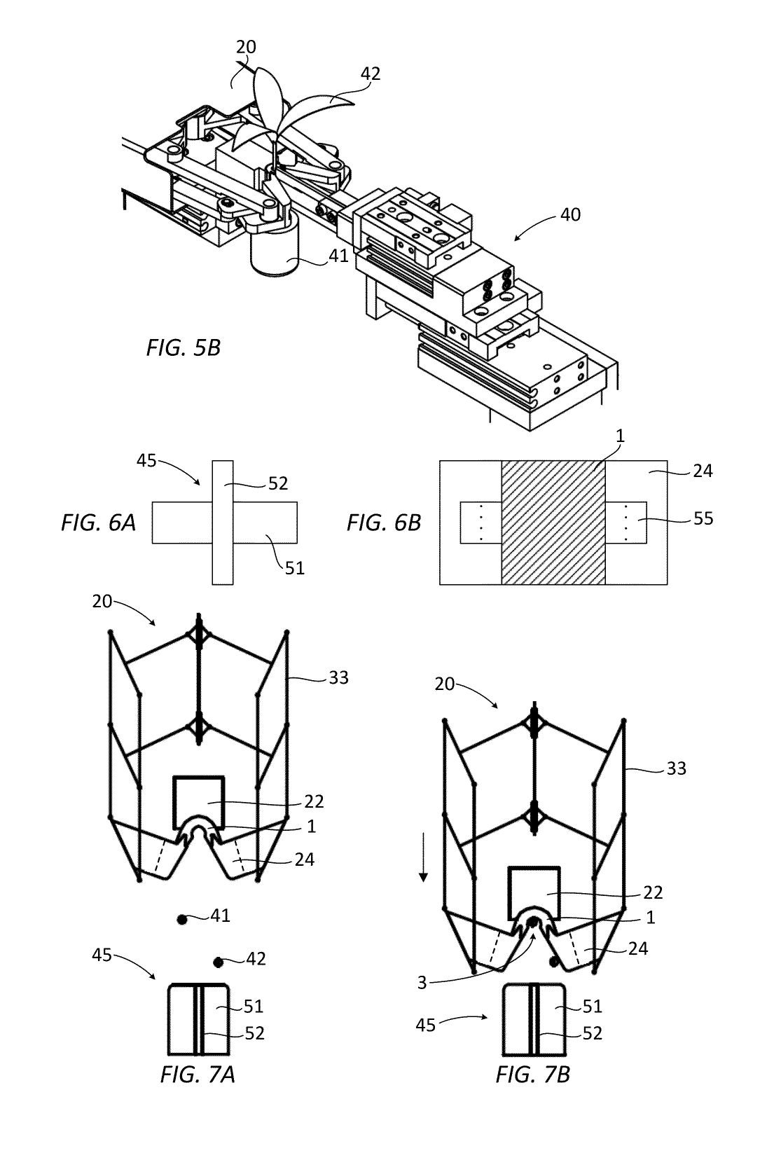

FIGS. 5A, 5B show an elevated view of an arrangement comprising a graft element gripping apparatus 20 at the left side and a graft application apparatus 40 at the right side for performing a graft application procedure according to an embodiment of the invention at two different stages within the procedure. In FIGS. 5A, 5B, the gripping apparatus 20 has made a rotational movement over about 90 degrees as compared to the orientation depicted in FIG. 2C. As a result, the graft element 1 has a substantially vertical orientation. The expression “vertical” corresponds to a direction that substantially corresponds with the direction of the force of gravity. It should be understood that the 90 degrees movement in a vertical plane is of course just a design choice. The supply of the graft element can be vertical, and the rotational movement may be rotational 45 degrees, 90 degrees or 180 degrees in a horizontal plane. Other designs can be thought of as well.

FIG. 5A shows a situation prior to application of the graft. The gripping apparatus 20 has positioned the graft element in the vicinity of a root stock 41 and a scion 42 to be joined together. The root stock 41 and the scion 42 are supported by respective supporting units. The supporting units are not shown in FIGS. 5A, 5B to limit the complexity of the drawings. The gripping apparatus 20 is further positioned such that the opening within the graft element 11 created by the gripping units 24 faces a stem positioning device 45 that is part of the graft application apparatus 40.

FIG. 5B schematically shows the situation in which the stem positioning device 45 has arranged placement of the stem of the root stock 41 and the stem of the scion 42 in the graft element held by gripping units 24.

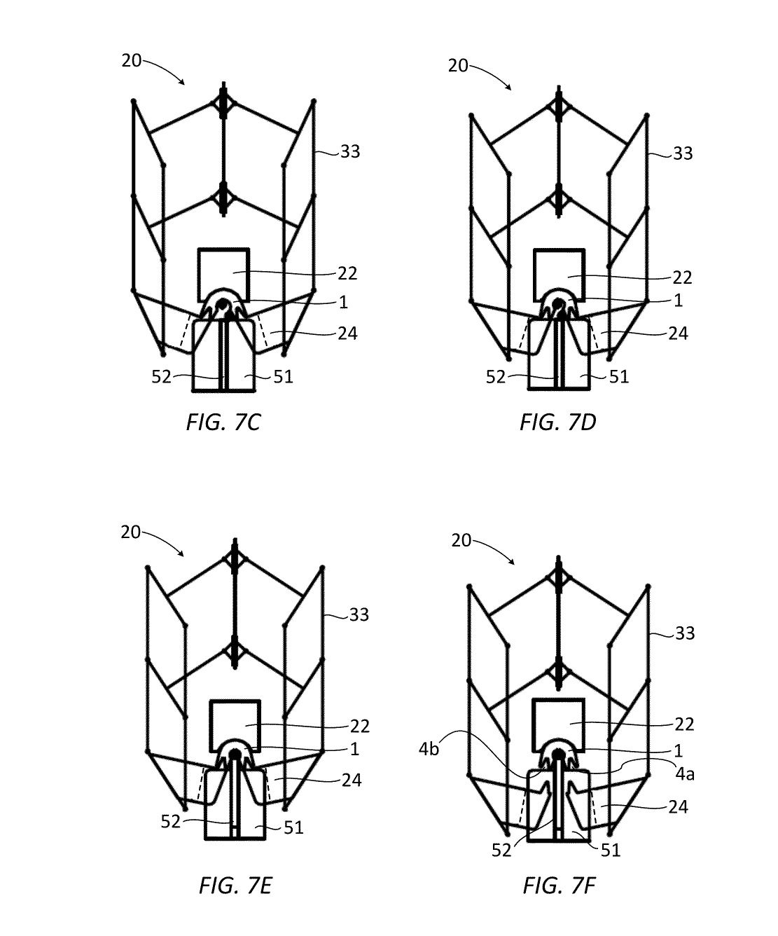

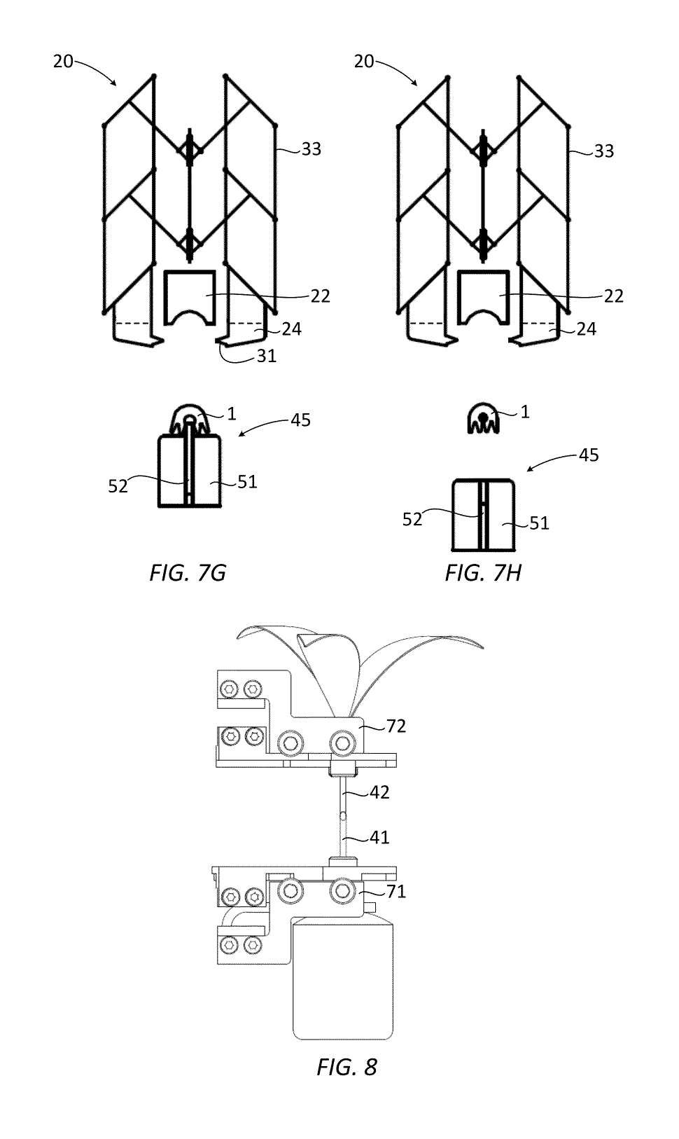

FIG. 6A schematically shows a side view of the stem positioning device 45 as seen from the graft element 11 at the stage shown in FIG. 5A. The stem positioning device 45 comprises main body, further referred to as pushing unit 51, and a pressing unit 52. The pressing unit 52 is oriented substantially perpendicular to the main orientation of the pushing unit 51 and can move independently thereof. Further details with respect to the orientation of the stem positioning device 45 in general and the pushing unit 51 and pressing unit 52 in particular will be discussed with reference to FIGS. 7A-7H.

FIG. 6B schematically shows a side view of the gripping units 24 holding the graft element 1 as seen from the stem positioning device 45 at the stage shown in FIG. 5A. The gripping units 24 comprise inner slits 55 for at least partly accommodating the pushing unit 51 of the stem positioning device 45. Furthermore, preferably, the pressing unit 52 is aligned with the center of the graft element 1. Further details with respect to the cooperation of gripping apparatus 20 and stem positioning device 45 will be discussed with reference to FIGS. 7A-7H.

FIGS. 7A-7H schematically show different stages of the graft element application procedure using the set up shown in FIGS. 5A, 5B.

In FIG. 7A the starting point is shown. The graft element 1 held by the gripping units 24 faces the pushing unit 51 of the stem positioning device 45 with the stems of the root stock 41 and the scion 42 in between.

Subsequently, the gripping apparatus 20 is moved towards the stems 41, 42 so that both stems are captured in the space between the gripping units 24. This situation is shown in FIG. 7B and resembles the situation shown in FIG. 5A. In this particular case, one stem 41 is already positioned within the center of the graft element 1 while the other stem 42 remains outside the area covered by the graft element 1. Note that it is not essential that one stem is already positioned within the center of the graft element 1 at this stage of the procedure. The stems 41, 42 merely need to be captured so that they are located within the space between the gripping units 24.

Next, as shown in FIG. 7C, the pushing unit 51 is moved towards the graft element 1. The pushing unit 51 slides through the slits 55 (boundaries depicted by dashed lines) of the gripping units 24 which ensures that the stem 42 is pushed towards the center of the graft element 1. Preferably, the dimensions of the pushing unit 51 and the slits 55 are designed to leave minimal space available between the two. Such minimal space avoids the risk of a portion of the stem getting stuck between the pushing unit 51 and the gripping unit 24 which would damage the stem.

Preferably, at this stage, the beaks 31 of the gripping units 24 rotate slightly towards each other, for example over about 8 degrees, which allows the opening 3 of the graft element 1 to decrease, and pushes the stems 41, 42 further inwards, an effect schematically shown in FIG. 7D. The opening of the graft element 1 is preferably such that the pressing unit 52 can just pass through.

Of course it is alternatively possible to perform movement of the pushing unit 51 as explained with reference to FIG. 7C and the inward rotation of the beaks 31 as explained with reference to FIG. 7D in an alternating and stepwise fashion to obtain the same result.

Now, as shown in FIG. 7E, the pressing unit 52 is moved through the opening 3 of the graft element 1 to push the stems so that both stems align with respect to each other in the center portion of the graft element 1.

At this stage, the gripping units 24 release the graft element 1 by removing the beaks 31 from the grooves 4a, 4b. The pressure applied by the pressing unit 52 keeps the stems 41, 42 in place with respect to the graft element 1.

Subsequently, the gripping apparatus 20 may move away from the graft element 1 as schematically shown in FIG. 7F.

Then the pressing unit 52 is retracted. Preferably the pushing unit 51 maintains its position to avoid any undesirable movement of the graft element 1, which results in the situation shown in FIG. 7G.

Finally, as shown in FIG. 7H, both the pushing unit 51 and the pressing unit 52 are retracted leaving the two stems 41, 42 provided with the graft element 1 thus forming a graft.

Instead of the sequence shown in FIGS. 7F-7H, alternative retractions procedures may be executed. For example, first the pressing unit 52 may be retracted followed by further closure of the opening angle by the gripping units 24. Then the pushing unit 51 may be retracted, followed by release of the graft element 1 by the beaks 31, and subsequent retraction by the gripping apparatus 20.

FIG. 8 schematically show a side view of a plant provided with a graft element 1 after usage after the procedure of FIGS. 7A-7H. The graft element 1 effectively joins together the stem of the root stock 41 with the stem of the scion 42. In FIG. 8 the grafted plant, which stem sections could have been held by the root stock holding apparatus 71 and the scion holding apparatus 72 during the grafting process, may now be supported by a separate support member (not shown) underneath the root stock 41. Such support member may be movable, for example within a carrousel or on top of a conveyor belt. It must be understood that other ways of support are possible as well.

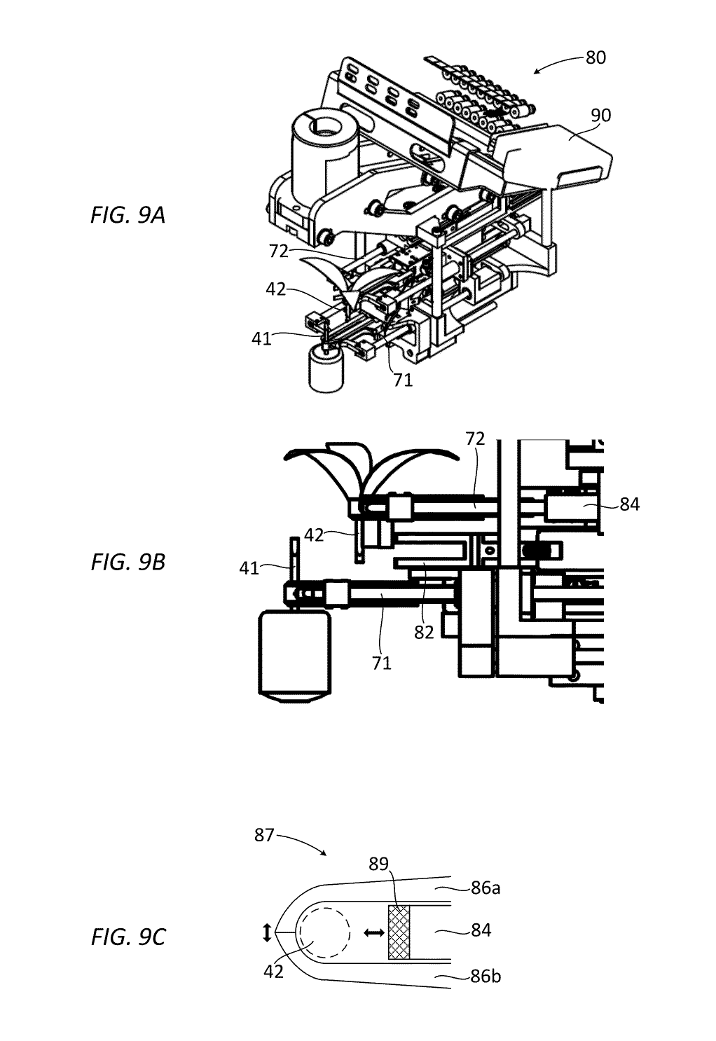

FIG. 9A schematically shows an elevated side view of a system 80 for joining together plant stem sections according to an embodiment of the invention. As shown in FIG. 9A, the system 80 comprises a root stock holding apparatus 71, a scion holding apparatus 72, a control unit 90 for controlling the holding apparatuses 71, 72. In addition, the system 80 comprises a cutting unit, and an apparatus for providing a graft element.

FIG. 9B schematically shows a side view of a portion of the system of FIG. 9A. The shown portion shows the root stock holding apparatus 71 holding a stem of a root stock 41 to be grafted and a scion holding apparatus holding a stem of a scion 42 to be grafted. Both stems 41, 42 are held in a substantially upright, i.e. vertical, position. Both stems are preferably pre-cut. For this purpose, the system may comprise a pre-cutting assembly for cutting at least one of the root stock stem 71 and the scion stem 72 prior to the method of joining stem sections discussed below.

The control unit 85 is arranged for controlling the root stock holding apparatus 71 and the scion holding apparatus 72 with respect to each other. In the embodiment shown in FIG. 9B, the scion holding apparatus 72 is moveable in a substantially horizontal direction using cylinder 84. The extent to which the scion holding apparatus 72 can move is limited due to the limited size of cylinder 84. An embodiment of a portion of a scion holding apparatus 72 that may be used in embodiments of the invention is shown in and discussed with reference to FIG. 9C. The system 80 further comprises a stem adjustment device for centering the stems 41, 42 in a direction substantially perpendicular to the drawing plane. In other words, the stem adjustment device 82 may limit sideway movement of the stems 41, 41. Positioning the stems 41, 42 in a line that is substantially parallel to the holding elements of the holding apparatuses 71, 72 improves cutting accuracy. The alignment of the stems 41, 42 with respect to each other in certain directions is more predictable and the cutting unit can anticipate such alignment. In particular, the stem adjustment device 82 may comprise to leaf springs that can be oriented with respect to each other in an open position and a closed position. While in the closed position, the leaf springs clamp the stems 41, 42 in a predictable way. Further details with respect to an embodiment of the stem adjustment device 82 will be shown with reference to FIGS. 11A-11C.

FIG. 9C schematically shows a top view of portion of a holding apparatus, in this exemplary embodiment the scion holding apparatus 72. Hereafter, reference is made to the term “ gripping unit 87” to refer to the shown portion. The gripping unit 87 comprises two gripping elements 86a, 86b forming beaks at their ends. The gripping elements 86a, 86b can move towards and away from each other, for example under the control of control unit 90, such that the beaks may be in an open or closed position. A stem 42 is placed between the gripping elements 86a, 86b while being spaced apart, after which the gripping elements 86a, 86b are moved towards each other until their ends meet and the scion stem 42 is protruding through a slit-shaped aperture. The gripping unit 87 further comprises a central pressing member 88 provided with a resilient end portion 89. The pressing member 88 is arranged to move along the length of the slit-shaped aperture, thereby decreasing or increasing the cross-sectional area of the aperture. In particular, after placement of a stem 42 between the gripping elements 86a, 86b so that the stem 42 protrudes through the aperture, the pressing member 88 may be moved, for example under control of control unit 90, towards the stem 42 until stem 42 is effectively clamped between the end portion 89 of the pressing member 88 and the inner surface of the gripping elements 86a, 86b. When the scion stem 42 is effectively clamped, the control unit may instruct the scion holding apparatus 72 to move the clamped stem 42 towards the root stock stem 41 held by the root stock holding apparatus 71.

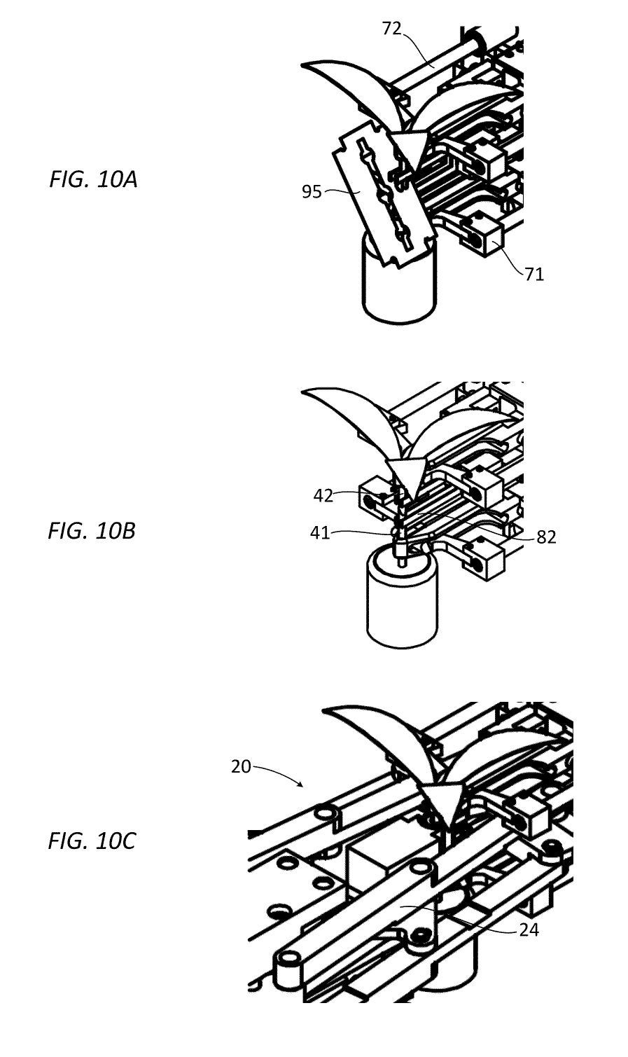

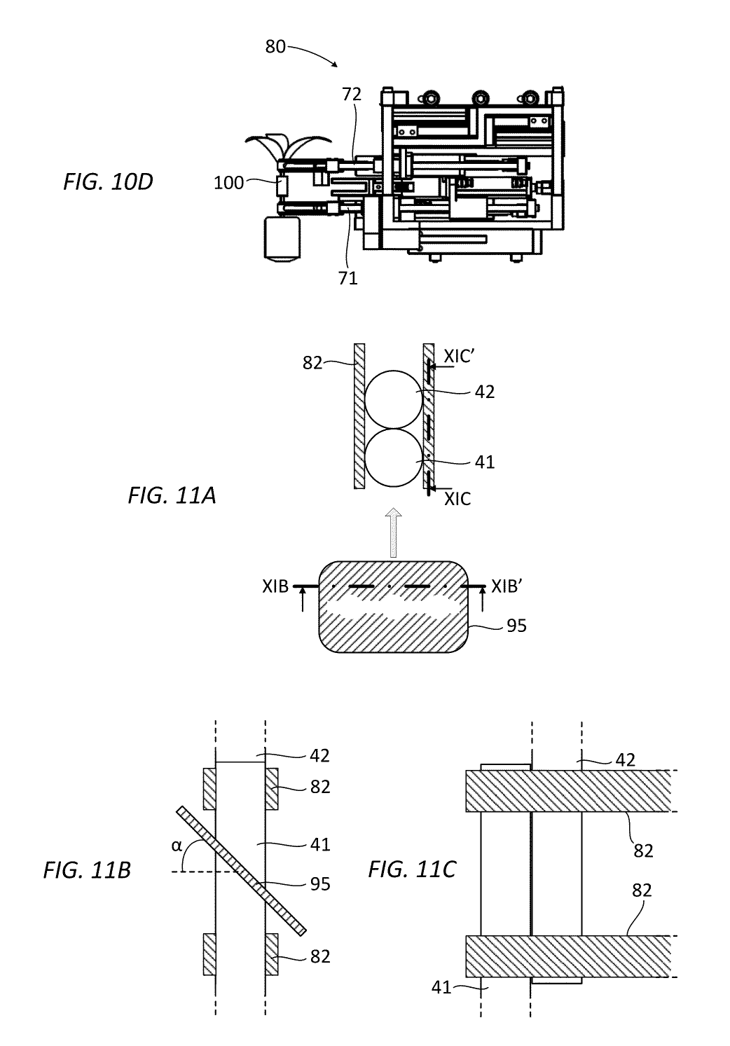

FIGS. 10A-10C schematically show an elevated side view of a portion of the system of FIG. 9A at different stages of joining together plant stem sections. In FIG. 10A, the root stock stem 41 and the scion stem 42 are positioned next to each other by movement of the scion holding apparatus 72 towards the root stock holding apparatus 71 holding the root stock stem 41. Preferably, the scion stem 42 is moved towards the root stock stem 41 until the scion stem 41 contacts the root stock stem 42. The stems 41, 42 are further positioned such that the root stock end hanging downwards is positioned at a higher level than the scion end facing upwards. In FIG. 10A, the stems 41, 42 are about to be cut with a cutting blade 95 that is part of a cutting unit. The cutting blade 95 cuts the stems 41, 42 in a single movement at a height level between the root stock end and the scion end. By cutting both stems 41, 42 in a single cutting movement the ends of both stems are cut with the same orientation. Consequently, both cut ends fit very accurately on top of each other. Due to this close fit, the graft accuracy is improved, which may result in an increased chance that the graft is executed successfully. Preferably, both stems 41, 42 are cut under an angle with the horizontal, i.e. at an angle with the direction substantially perpendicular to the main orientation of the stems 41, 42. The angle of the cutting blade 95 is preferably adjustable. The most suitable cutting angle may vary on the type of plant that is to be grafted. The angle is preferably between 0° and 60° with the direction substantially perpendicular to the main orientation of the stems 41, 42.

In FIG. 10B the cut ends of the cut root stock stem 41 and the cut scion stem 72 are positioned on top of each other. In an embodiment, both holding apparatuses 71, 72 comprise a gripping unit similar to gripping unit 87 shown in FIG. 9C. The scion holding apparatus 72 is movable as described above, whereas the root stock holding apparatus 71 has a fixed position. The extent to which the scion stem 72 can be moved, e.g. by suitably dimensioning the cylinder 84, may then be designed such that the position of the inner surface of the beaks of the scion holding apparatus 72 in fully extended position are aligned with the position of the inner surface of beaks in closed position of the root stock holding apparatus 71.

Thereafter, as shown in FIG. 10C, a graft element 100 is provided around the cut stem ends 41, 42, thereby forming a graft. The graft element 100 may be a graft element 1 as described with reference to FIGS. 1A or 1B. In such case, as shown in FIG. 10C, the apparatus for providing the graft element may comprise a gripping apparatus 20 comprising two gripping units 24 provided with extended portions. The gripping units 24 are then arranged for holding the graft element and controllably opening the side opening 3 of the graft element 1 against a repelling force of the resilient material.

FIG. 10D shows a side view of the system 80 with the end result, a scion grafted onto a root stock using a graft element 100.

FIGS. 11A-11C schematically show different views on an arrangement for cutting stem sections according to an embodiment of the invention. FIG. 11A shows a top view of the stems 41, 42, and a cutting blade 95 that is part of the cutting unit and arranged for cutting the stems 41, 42 in a single cutting movement.

FIG. 11B shows a side view of the arrangement of FIG. 11A along the line XIB-XIB′ in FIG. 11A while looking in the direction of the arrows. The cutting blade 95 is arranged to cut the stems at an angle α. Preferably, the angle α is between 0° and 60° with a direction substantially perpendicular to the orientation of the stems 41, 42. The most suitable angle α may depend on the type of plant to be grafted.

FIG. 11C shows a side view of the arrangement of FIG. 11A along the line XIC-XIC′ while looking in the direction of the arrows. As already discussed with reference to FIG. 10A, FIG. 11C shows that the root stock end extends above the scion end. The cutting blade 95 is arranged to cut both stems at a level between both ends. The cutting of both stems 41, 42 in a single movement ensures that both stems 41, 42 have cut stem ends with the same orientation. Consequently, the cut stems fit very well onto each other.

The invention has been described by reference to certain embodiments discussed above. It will be recognized that these embodiments are susceptible to various modifications and alternative forms well known to those of skill in the art without departing from the spirit and scope of the invention. Accordingly, although specific embodiments have been described, these are examples only and are not limiting upon the scope of the invention, which is defined in the accompanying claims.

1. Graft element for joining together plant stem sections, the graft element being made of a resilient material and taking the form of a tubular structure having a hollow center that extends in a longitudinal direction of the graft element so as to form a cylinder, the graft element further comprising:
a side opening along its length which is connected to the hollow center over the entire length of the graft element; and
two elongated members at opposite sides of the side opening and oriented substantially parallel thereto, the elongated members being provided with cutouts;
wherein the side opening is expandable under the influence of one or more gripping units that fit into the cutouts.

2. Graft element according to claim 1, wherein the cutouts of the elongated members take the form of grooves.

3. Graft element according to claim 2, wherein the cross-sectional shape of the grooves is substantially wedge-shaped.

4. Graft element according to claim 1, wherein the cutouts of the elongated members take the form of tubes.

5. Graft element according to claim 1, wherein the cylinder has a substantially circular cross-section.

6. Graft element according to claim 1, wherein the width of the side opening close to the inner surface of the cylinder is smaller than the width near the outer surface of the graft element.

7. Graft element according to claim 6, wherein the cross-sectional shape of the side opening is substantially wedge-shaped.

8. Method for joining together plant stem sections by means of a graft element according to claim 1, the method comprising:
providing a graft element by means of a gripping apparatus comprising two gripping units provided with extended portions, the gripping units being arranged for holding the graft element and controllably opening the side opening against a repelling force of the resilient material;
providing a stem of a root stock to be grafted;
providing a stem of a scion to be grafted; and
positioning the stems of the root stock and the scion in the graft element by pushing the stems through the side opening by means of a stem positioning device so as to allow the formation of a graft.

9. Method according to claim 8, wherein the method further comprises keeping the stems at a predetermined position by applying pressure to the stems by means of the stem positioning device.

10. Method according to claim 9, wherein the predetermined position is located in the center portion of the graft element.

11. System for joining together plant stem sections by means of a graft element according to claim 1, the system comprising:
a gripping apparatus comprising two gripping units provided with extended portions the gripping units being arranged for holding the graft element and controllably opening the side opening against a repelling force of the resilient material;
a root stock holding apparatus for providing a stem of a root stock to be grafted;
a scion holding apparatus for providing a stem of a scion to be grafted; and
a stem positioning device for positioning the stems of the root stock and the scion in the graft element by pushing the stems through the side opening so as to allow the formation of a graft.

12. System according to claim 11, wherein the stem positioning device comprises a pushing unit for pushing the stems, the pushing unit having an orientation substantially perpendicular to the main orientation of the stems.

13. System according to claim 12, wherein the stem positioning unit further comprises a pressing unit for applying pressure to the stems at a predetermined position, wherein the pressing unit is oriented substantially perpendicular to the pushing unit and independently moveable thereof.

14. (canceled)

15. Method for preparing the graft element of claim 1, the method comprising:
supplying a strand of graft element material;
gripping a portion of the strand; and
cutting the strand so that the graft element is formed.
wherein the gripping is performed by a gripping apparatus comprising a graft element supporting unit having a supporting surface for supporting the strand portion, and two gripping units provided with extended portions with a shape complementary to the elongated members of the graft element to be formed, wherein the method further comprises moving the elongated members away from each other so that the strand portion is effectively clamped on the supporting surface.

16. (canceled)

17. System for preparing the graft element of claim 1, the system comprising:
a supply unit for supplying a strand of graft element material;
a gripping apparatus for gripping a portion of the strand; and
a cutting device for cutting the strand so that the graft element is formed.
wherein the gripping apparatus comprises:
a graft element supporting unit having a supporting surface for supporting the strand portion; and
two gripping units provided with extended portions with a shape complementary to the elongated members of the graft element to be formed;
wherein the gripping units are arranged to move the elongated members away from each other so that the strand portion is effectively clamped on the supporting surface.

18. (canceled)

19. Method for joining together plant stem sections by means of a graft element, the method comprising:
providing a stem of a root stock to be grafted, the root stock stem comprising a root stock end for receiving the scion stem;
providing a stem of a scion to be grafted, the scion stem comprising a scion end for receiving the root stock stem;
positioning the stems next to each other such that the root stock end is positioned higher than the scion end;
cutting the stems at a level between the root stock end and the scion end and positioning the stems of the root stock and the scion on top of each other; and
providing a graft element around the cut stems.

20. Method according to claim 19, wherein cutting the stems is executed with a cutting blade that cuts the stems at an angle between 0° and 60° with a direction substantially perpendicular to the orientation of the stems.

21. Method according to claim 19, wherein the graft element is a graft element according to claim 1, and wherein providing the graft element is performed by means of a gripping apparatus comprising two gripping units provided with extended portions, the gripping units being arranged for holding the graft element and controllably opening the side opening against a repelling force of the resilient material.

22. System for joining together plant stem sections by means of a graft element, the system comprising:
a root stock holding apparatus for providing a stem of a root stock to be grafted, the root stock stem comprising a root stock end for receiving the scion stem;
a scion holding apparatus for providing a stem of a scion to be grafted, the scion stem comprising a scion end for receiving the root stock stem;
a control unit for controlling the root stock holding apparatus and the scion holding apparatus for positioning the stems next to each other such that the root stock end is positioned higher than the scion end;
a cutting unit; and
an apparatus for providing the graft element;
wherein the cutting unit is arranged for cutting the stems at a level between the root stock end and the scion end and wherein the control unit is further arranged for controlling the root stock holding apparatus and the scion holding apparatus for positioning the stems of the root stock and the scion on top of each other after cutting.

23. System according to claim 22, wherein the cutting unit comprises a cutting blade with an orientation at an angle between 0° and 60° with a direction substantially perpendicular to the orientation of the stems to be cut.

24. (canceled)
